(19) United States
(12) Patent Application Publication
(10) Pub. No.: US 2014/0136517 A1
(43) Pub. Date: May 15, 2014

(54) Apparatus And Methods for Providing Search Results

(71) Applicant: Chian Chiu Li, Fremont, CA (US)

(72) Inventor: Chian Chiu Li, Fremont, CA (US)

(21) Appl. No.: 13/674,027

(22) Filed: Nov. 10, 2012

(51) Int. Cl. G06F 17/30

(52) U.S. Cl. 707/722; 707/E17.014

(57) ABSTRACT

In one embodiment, online posts are processed by automatic analysis to generate a concise summary which has limited quantity of words and/or symbols for quick and easy viewing. In embodiments involving multiple searches based on one query, a concise summary on posts is complemented by general search results, or a general internet search is complemented by concise summaries on relevant posts. In other embodiments, comparable search results are generated and shown together based on multiple query subjects in the same or similar categories.

### CROSS REFERENCE TO RELATED APPLICATION

This application claims the benefit under 35 U.S.C. Sec. 119 of provisional patent application Ser. No. 61/598,353, filed Feb. 14, 2012.

### FEDERALLY SPONSORED RESEARCH

Not applicable

### SEQUENCE LISTING OR PROGRAM

Not applicable

### BACKGROUND

1. Field of Invention

This invention relates to information retrieving, processing and presentation, more particularly to search result retrieving, processing and presentation in response to a search query.

2. Description of Prior Art

The Internet has become a colossal reservoir of data where we have been accumulating endless information, which includes knowledge, history, event, experience, action, or in some occasions, any digital signals we could catch on it. The Internet also provides us with a platform where a user can conveniently publish to the public or post his or her ideas or opinions. The opinions, for example, if generated by posters having experience of a product, would be very helpful for potential buyers. There are numerous web sites where a user can leave comments or posts, and there are many web sites whose main purpose is to let users express thoughts or opinions. As the volume of posts is large, from hundreds to thousands or more, in reality no one would wade through all of them, or even the majority of them. The situation becomes even worse for smartphone users in front of or inside a store, where it is urgent to make a quick decision, but time might not be enough to go through even one post.

Therefore, there exists a need to make a large quantity of posts easy to read and comprehend.

Current search engines are designed to deal with one query and to provide search results in one form. A general internet search, like ones made by Google or Bing, is meant to cover the whole Internet. Such searches produce a list of links to web pages. Users' comments or posts, on the other hand, are displayed in sequence on some web sites or web pages. The two kinds of search may employ different strategies, and are usually executed separately in unrelated cases. There is no effort to combine a general search with a comment or post search to enhance the searching experience.

Therefore, there exists a need to combine various search results, in particular a general search and a comment or post search for providing richer and more effective information.

The term “web site” or “website” is broadly referred to any domain or subdomain or a domain plus a uniform resource locator prefix. The term “document” is referred broadly to any machine-readable and machine-storable information, or any information in a digital format, including textual information, a web page, image file, audio file, video file, other web files, embedded information, etc.

The word “post” as verb or “posting” is referred broadly as transmitting information from a user to a server via a communication network to let others in a certain environment view the transmitted information. The word “post” as noun includes information posted or submitted by a user on the Internet, or user generated content on the Internet or in any network. Posted information may cover a hyperlink or a uniform resource locator (URL), audio, video, an image, a symbol, a sign, a word, a number, a reply, a message, an e-mail, news article, blog entry, survey, etc. In practice, a user may or may not be allowed to post information without registration. Posts are preferably hosted on a web site, but may also be hosted locally using local database or local server system. Posts are preferably used as a form of publishing or submitting own opinions and/or reviewing other's opinions, but may additionally or alternatively be used as a form of micro-blogging, data search and collection, comments, survey, messaging, gaming, and/or other suitable applications. Commonly posted information on a daily basis includes opinion, experience, comment, feedback, story, thought, claim, or expression on anything by textual, graphic, or other formats, which may be found among numerous web sites.

### OBJECTS AND ADVANTAGES

Accordingly, several main objects and advantages of the present invention are:
a). to provide an improved system and method to retrieve and present post search result;
b). to provide such a system and method which automatically summarize numbers of posts to generate a clear and concise summary;
c). to provide such a system and method which produce a concise summary on numbers of posts using chart, curve, grade, or a few words and symbols;
d). to provide such a system and method which produce multiple concise summaries for evaluating a subject by comparison; and
e). to provide such a system and method which combine a general search result with a concise summary of posts to provide richer and more effective information.

Further objects and advantages will become apparent from a consideration of the drawings and ensuing description.

### SUMMARY

In accordance with the present invention, numbers of posts are retrieved from server systems and from the Internet in response to a search query. Automatic summarization is employed to extract the key information from each post and then generate a concise and easy to read summary. The summary may be a short text, limited words, a number, grade, chart, or a curve, which would be useful for smartphone users who may be in a hurry to get instant results. In addition, a general search on the query may be performed to complement an online post search, and vice versa. Furthermore, the second query may be generated automatically to enable the second search on posts of a comparable subject relative to the original query. Comparable search results may provide helpful information for potential buyers.

### DRAWING FIGURES

FIG. 1 is a block diagram showing a prior-art network environment.

FIG. 2 is a block diagram showing a prior-art server 16 of FIG. 1.

FIG. 3 is a schematic block diagram of log processing system of the server in accordance with the present invention.

FIG. 4 is a schematic block diagram of searching system of the server in accordance with the present invention.

FIG. 5 is a schematic flow diagram showing search result processing in accordance with the present invention.

FIG. 6 is a schematic flow diagram showing search result processing and presenting in accordance with the present invention.

FIGS. 7-9 are exemplary charts and curves showing different ways to present search results graphically.

FIGS. 10-15 are exemplary diagrams showing methods to perform search and present search results on a display.

REFERENCE NUMERALS IN DRAWINGS

| 10 Client | 12 Communication Network |
|---|---|
| 14 Input Module | 16 Server |
| 18 Output Module | 20 Presentation Module |
| 22 Memory & Storage | 24 Processing Module |
| 26 Communication Interface | 28 Bus |
| 30 Front End | 31 Log Processing System |
| 32 Processing Unit | 33 Searching System |
| 34 Site Storage | 36 Log Data Storage |
| 38 Search Module | |
| 300, 302, 304, & 306 Steps | |
| 310, 312, 314, 315, 316, 318, 320, 322, & 326 Steps | |
| 328 Display | 330 Window |
| 332 Window | 334 Window |
| 336 Display | 338 Window |
| 340 Green Light | 342 Speaker |
| 344 Display | 346 Window |
| 348 Window | 350 Display |
| 352 Window | 354 Window |
| 356 Display | 358 Window |
| 360 Window | 362 Display |
| 364 Window | 366 Window |
| 368 Window | 370 Window |

### DETAILED DESCRIPTION

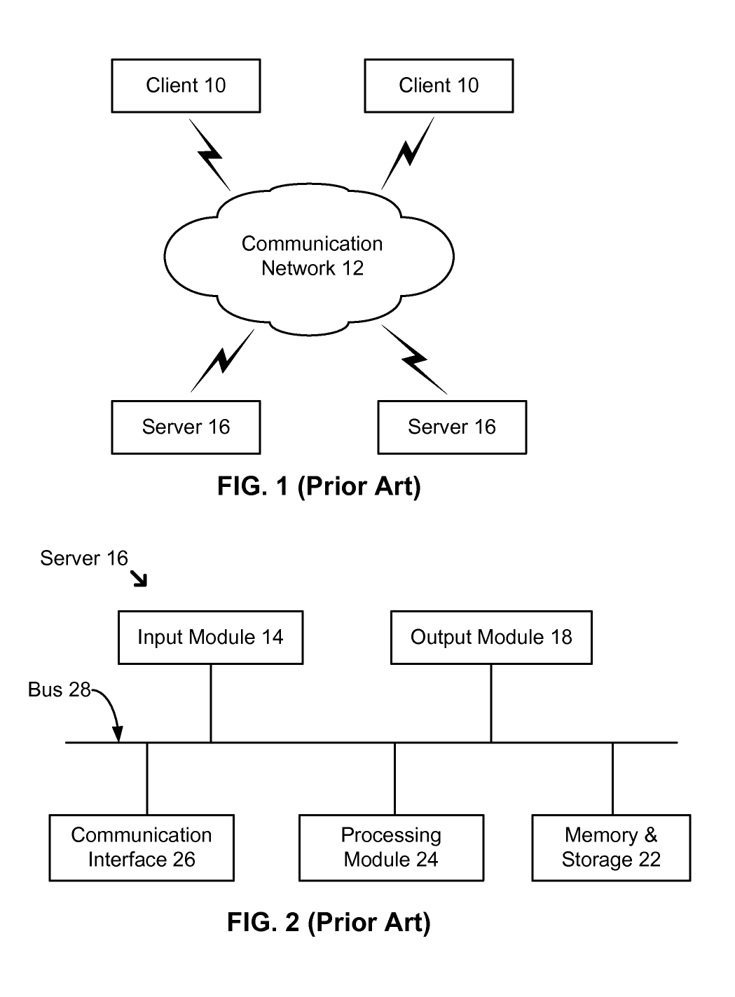

### FIGS. 1 and 2—Prior-Art

FIG. 1 is an exemplary diagram of prior-art network system which may be used to implement the principles of current invention. The network system may involve clients 10 and servers 16 which are connected via a communication network 12. The numbers of users and servers in FIG. 1 are arbitrary for showing principles only. The clients or servers may be the same or different in characteristics and their functionality may change in practical applications.

Clients 10 may cover a range of entities such as a thread or process running on a devices, or an object executable by a device, an electronic device, e.g. a computer, a wireless gadget (such as mobile phones, smartphones, personal digital assistants (“PDAs”)), digital television (DTV), internet protocol television (IPTV), and play stations, etc.

The word “server” used in below means a system or systems which may have similar functions and capacities as one or more servers. Main components of server may include one or more processors, which control and process data and information by executing software, logic, or code, or carrying out any other suitable functions. A server and/or processor, as a computing device, may include any hardware, firmware, software, or a combination. In the most compact form, thanks to the progress of microelectronic technologies, a server may be built on a single processor chip. In the figure, servers 16 may represent one or more server entities that collect, process, maintain, and/or manage information and documents, execute searches requested by users and deliver search results to users.

Network 12 may cover a range of entities such as a local area network (LAN), a wide area network (WAN), a telephone network, an intranet, the Internet, wireless, and other types of networks. Clients 10 and servers 16 may be connected to network 12 or among themselves by various wired, wireless, optical, direct or relayed connections.

FIG. 2 is a schematic block diagram of prior-art server 16 which is depicted in FIG. 1. Server 16 may comprise an input module 14, an output module 18, a memory & storage module 22, a processing module 24, a communication interface 26, and a bus 28. Bus 28 provides communication means among the devices.

Input module 14 may comprise a function that permits and enables an operator to feed information to server 16. Keyboard, mouse, voice or gesture recognition devices are examples of module 14. Output module 16 presents or displays output information. Examples of output module are monitor, printer, smart phone, or other information output devices. Memory & storage module 22 may comprises random access memory (RAM), read only memory (ROM), magnetic storage, optical storage, or other memory and storage media. Processing module 24 may comprise various types of processors which receive and execute instructions. Communication interface 26 may comprise any communication mechanism that enables server 16 to exchange information with other devices and systems either locally through bus 28 or remotely through network 12.

Processing module 24 may process information obtained from various web pages or web sites, generate data associated with the web sites, and then store the data using memory & storage 22. Module 24 may also access information stored in memory & storage 22 to acquire needed data. Module 24 may perform these operations in response to executable software instructions contained in a computer-readable medium, such the RAM or ROM part of device 22.

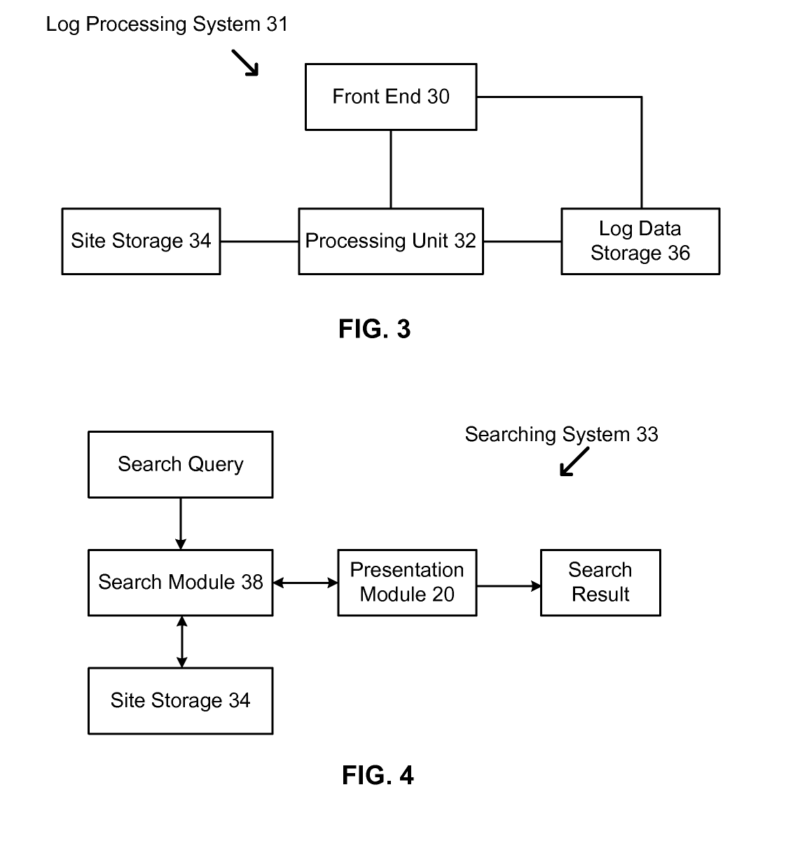

### FIGS. 3 and 4 Processor Functions

The following exemplary embodiments are provided for complete disclosure of the present invention and to fully inform the scope of the present invention to those skilled in the art, and the present invention is not limited to the schematic embodiments disclosed, but can be implemented in various types.

FIG. 3 is a schematic functional block diagram of log processing system 31 of the server according to the present invention. System 31 may comprise a front end 30, a processing unit 32, site storage 34, and log data storage 36. The blocks each may represent processor, thread, and/or object. The blocks or functions depicted here and in other figures may be implemented in software, hardware, or a combination of hardware and software. Using integration or system-on-chip technologies, system 31 and other systems described here may also be built by less blocks or chips, or even a single block or single chip to realize functions pursued, and to reduce the system size and power consumption.

Front end 30 works as the front end of log processing system 31 and receives information related to users and user access of web pages and web sites such as hypertext transfer protocol (HTTP) requests. Web access information of users includes visits on various sites and web pages where posts are displayed, which may be sent to and stored in log data storage 36. Log storage 36, as shown in FIG. 3, may be directly connected to front end 30. It stores data transferred from front end 30, which may include other user related info which are either submitted by users or collected via other means, such as user name, password, IP address, geographic location, online posting record, online purchase record, etc.

Processing unit 32 may analyze a user by the information stored in log data storage 36 and send analysis results to site storage 34. The results may illustrate user activity, history, and habit while surfing on the Internet. Main functions of site storage 34 may include collecting and storing information on various subjects, especially posts on certain topics, which also comprises part of or all related documents retrieved by a server or through search engines of other web sites, such as Google and Bing. Information stored in site storage 34 may include collection of posts from major websites, other post-related media and multimedia like texts, video, audio, links to web pages, as well as web site related info such as site address, web page contents, visit history, and lists of website on selected issues.

FIG. 4 is a schematic functional block diagram of searching system 33 of the server according to the present invention. The functions illustrated in FIG. 4 may be realized by software, hardware, or a combination of hardware and software. The blocks each may represent processor, thread, and/or object. And the blocks can be integrated into less blocks or one block without changing the functions. A search query may be any text a user submits to searching system 33. After a query is received, searching system 33 may search the site storage and the Internet accordingly, and utilize the search data to produce consolidated search results, which may be presented to users by text, charts, web site lists or links to web pages, etc.

System 33 may comprise a search module 38 and a presentation module 20, while in practice the two modules may be combined into one device. After search module 38 receives a search query from a user, it may analyze the query, identify the issue, access site storage 34 and/or the Internet to retrieve relevant documents, and then generate the initial search result, which is sent to presentation module 20. Module 20 may further process the result and arrange a way the search result is provided to a user and send to the user the search result in text, charts, other graphic display, or other applicable forms. The functions of presentation module 20 may include categorizing/sorting, calculation, automatic analysis/summarization, automatic translation from one language to another language, chart and curve drawing, or other ways to present search results. The manner a search result is displayed is determined by user preference, analysis on user viewing history, or any predetermined arrangement. As said, search module 38 may have the capacity to access documents on the Internet and documents of other servers, and to obtain results utilizing external search engines like Google or Bing. This part, comprising searching using the site storage and outside search engines, is not shown in FIG. 4 for simplicity reason. After completing a search, the search results and related data obtained locally and on the Internet may be recorded in site storage 34 for future use purpose. For hot subjects or issues, related posts and information may be collected and organized periodically to keep them up to date, such that upon receiving a query, search module may just access storage 34 to retrieve the result without launching extensive searches.

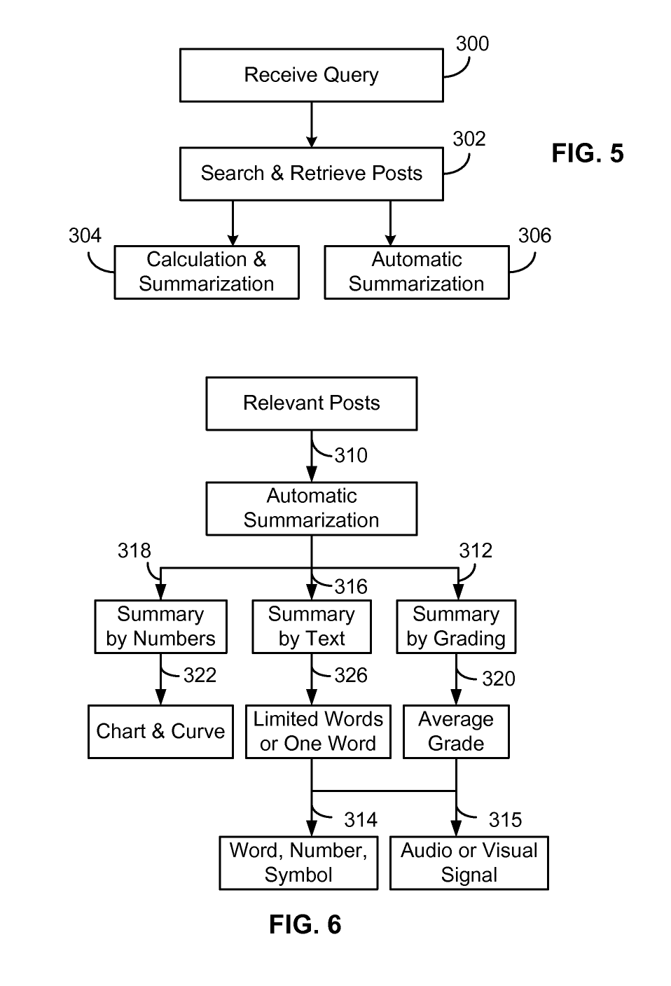

### FIGS. 5 and 6 Search Result Processing and Presentation

FIG. 5 is an exemplary flow diagram on post retrieving and processing performed by searching system 33 of FIG. 4 in accordance to present invention. In Step 300, search module 38 receives a query from client 10. In Step 302, search module 38 searches posts in site storage 34 and on the Internet. Step 302 may be conducted by searching site storage 34 only when the storage is updated regularly, and it may also utilize outside search engines at www.google.com or www.bing.com. After the search is completed, related posts are collected and search results are sent to presentation module 20 of FIG. 4. In Steps 304 and 306, presentation module 20 may respectively perform calculation & summarization and automatic analysis & summarization on search results.

Assume a search generates numbers of posts. It would be helpful if the posts are processed such that a concise summary can be presented to a user. Step 304, calculation & summarization, may be useful for those posts which contain a grade on a subject. On some web sites for example, when posting a comment on a product or service, a poster may have a chance to submit a grade, like one to five stars. In other examples, some posts may contain only a grade, or a word or sentence as a grade. For example, a survey of 100 users may be treated as 100 posts where each user's answer represents the content of a post. If a poster or user can choose a level of quality, satisfaction, or the like, such as from “very bad” to “very good”, the level may be converted to a number or grade without the need of analysis. Thus step 304 may be configured to collect grading value of all relevant posts, and then calculate the average value. The average value may be used as a concise summary for the posts.

However, many posts submitted may not have a grading value with it. As a result, Step 306, automatic summarization, may be used to automatically analyze the posts respectively, summarize them one by one, and then produce a concise summary of all the posts.

A concise summary of search result is especially useful for mobile device users, as they may be on the move and may not have time for investigating web sites or web pages, or reading relevant posts. As a result, it may be configured that when a query is sent by a handheld mobile device, e.g. PDA or cellular phone, a reply to the user may automatically include a concise summary, or only contain a concise summary. If the user needs more detail, he may exercise more options to access regular search result, which usually contains list of links to web pages. By sending a concise summary automatically, it may satisfy the need of mobile device user by providing simplified search process and easy to read result.

Because it takes time to retrieve information and to create a summary out of it, summaries of popular topics and summaries obtained previously may be stored at site storage 34, and be frequently updated. The collected summaries may be arranged to form a summary system, which may be organized or classified by query subjects for efficient search and retrieval. When search module 38 receives a query from a user, it may start a regular process, searching locally and on the Internet and transferring search result to presentation module 20 for producing a summary. With a summary system, it may search at site storage 34 to see whether there is a summary available. If there is a ready summary, the summary may be sent to the user directly. The summary system may contain information locally created, as well as obtained from other servers and the Internet.

FIG. 6 is an exemplary flow diagram on post processing and presentation performed by system 33 as illustrated in FIG. 4 in accordance to present invention. In Step 310, retrieved posts are sent from search module 38 to presentation module 20 for automatic analysis or automatic summarization. The retrieved posts may include all relevant posts from site storage 34, as well as posts obtained from the Internet, i.e. relevant information or documents from the Internet. Because in many occasions, there may exist a large quantity of posts on a subject, for example from hundreds to thousands, presentation module 20 may be designed to automatically analyze and summarize the posts, and convert the posts into a concise summary, such as a concise text with limited words, a chart, curve, grade, or other formats for easy read or review.

In Steps 312 and 320, auto summarization is utilized to translate each post into a grade, and then calculate the average grade of all relevant posts. A post about a subject may be analyzed and graded according to predetermined rules and procedures. The grade is a result of analysis, derived from text, graphic expression, or other forms of post contents. A grade may be certain points out of 100. For example, if a post on a product describes satisfactory experience, the post may get 80 points by predetermined standards. After every eligible posts are graded, the average point may be easily obtained, which may represent the average opinion of posters in regard to the product. Such a grading system may give users a clear and concise opinion.

In Steps 316 and 326, the auto summarization may summarize part or all of the relevant posts to create a textural summary, which is preferably to be adequately short for easy and quick viewing. For example, the length of the summary may be set with maximum words of 50, including symbols, signs, numerical numbers, language characters, small images, and other symbols. In real life, when a user is at a store searching for online opinions on a new gadget, he may be swarmed by hundreds or thousands of posts and he may not have a chance to read through even one post. With the auto summarization function, he may get a short text which is resulted from part or all of the relevant posts. Thus the user may no longer need to spend time dealing with many posts and making a summary himself or herself, and may make a decision in a timely manner. The posts may come from site storage 34 and/or the Internet. A summary is preferably to be concise and easy to read. A summary condensed from part or all of the relevant posts may be preferred to have a few members or words, like “Service is satisfactory”, “Product is good”, “Good quality good price”, “Fried chicken so-so ribs good”, etc.

In Step 314, a summary may be configured to contain only one word, such as “Good”, “Worthy”, “Pleasant”, or “Angry” in response to a query. The word may be combined with a symbol/symbols or sign/signs, like “Good+”. A summary may only contain letter, symbol, sign or a combination, such as A, A+, * * * (three stars), or ++ (two plus signs). The summary generated by Step 314, although very concise, may represent the main opinion of the posts, e.g. hundreds or thousands from one or multiple sources or web sites. It would be useful for mobile phone users who often demand a simple and effective answer. Summary of such types, especially those relating to popular subjects, may be stored in a summary system in site storage 34 and updated regularly so that the time needed for producing a summary may be greatly reduced. Another form of concise summary may combine a word with a grade as derived from Step 312 and 320. The result, e.g. “Good 92 Pts”, where 92 pts means 92 points out of 100, may represent a short answer with depth. A summary may also take audio or visual forms, as illustrated in Step 315, or any combination of word, symbol, sign, letter, number, grade, audio, video, light, etc. For example, a summary may be presented by a short piece of music, flashes of color light, an image, or a clip of video, where a user may decide the meaning of each action.

In Step 318 and 322, the auto summarization is used to summarize part or all of the relevant posts in yet another way. For every post, an opinion and/or judgment may be determined by auto analysis. For example, analyzing a textural post may yield opinions like “The service is good”, “The experience is pleasant”, or ‘Price is good”. After all relevant posts are analyzed, the quantity of posts having “The service is good” may be calculated, so are the number of posts with other opinions. For example, there may be 200 posts containing opinion “The service is good”. The number 200 in turn may be used to produce graphic display like charts and curves for quick, easy and convenient viewing, which will be described in more detail below.

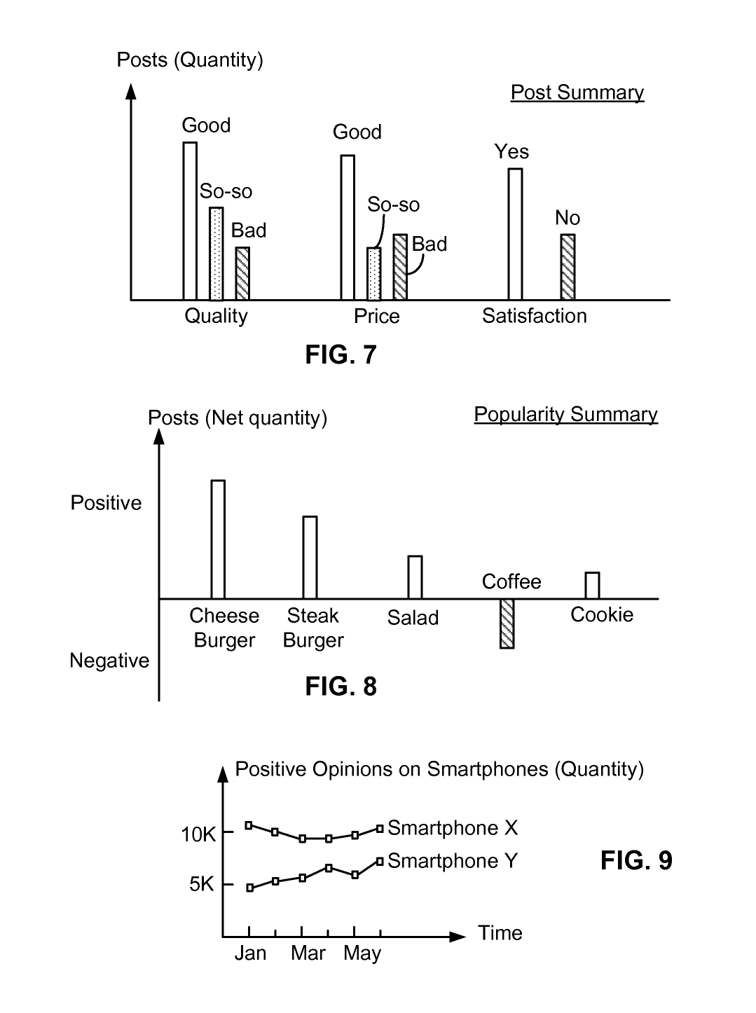

### FIGS. 7-9 Search Result Processing and Presentation

In FIG. 7, an exemplary chart shows posters' opinions on quality, price, and satisfaction regarding, for example, an auto repair shop. It may get started from receiving a query on the auto repair shop. Searching system 33 may perform searches on the shop, conduct automatic summarization, and then sort the outcome by major characteristics (quality, pricing, customer satisfaction, etc). The chart may be produced based upon all posts about the shop from various sources. It clearly shows the number of posters who like it or dislike it. This is one way to display search results for simple, quick and effective viewing. If the posts already contain the info, the data may be picked up directly and aggregated. Then a chart may be created. Alternatively, the quality, price, and satisfaction info may be extracted from each post by module 20 through auto analysis or auto summarization.

In FIG. 8, another exemplary case is made to show posters' opinions on multiple subjects in one chart. When searching system 33 receives a query about a fast food eatery, it may collect and process all related posts. Opinions on the eatery as a whole may be extracted, as well as opinions regarding specific items on the menu. The latter may be shown graphically as a popularity summary. In the figure the columns represent food items selected for the survey. Column height reflects the net quantity of posts, where a positive opinion contributes one positive point, a neutral opinion zero point, and a negative opinion contributes one negative point. For each item, the positive and negative numbers are added together to get the net value, which could be either positive or negative. For example, if there are 400 positive comments and 50 negative comments on a subject, the result would be positive 350; vice versa, the number would be negative 350. As shown in the figure, net positive comments dominates on cheese burger, steak burger, salad, and cookies, while net negative comments show up on coffee. Again, if the posts don't carry the opinion info directly, module 20 may be used to execute auto summarization, which may extract the needed info from the post and then add it to data base for producing a chart. Compared to the chart of FIG. 7, the chart here is less crowded and easier for viewing.

FIG. 9 shows exemplary curves reflecting trend of opinions on smartphones over a period of time, say from January to June. Sometimes a user may want to compare two products. Searching system 33 may be configured to conduct two searches separately and generate two results. Again the quantity of positive and negative opinions may come from posts directly if it is available, or may be derived analytically from posts through auto summarization as aforementioned. The curve provides a clear and simple picture for a quick and easy review. As there are two curves about smartphone X and smartphone Y respectively, the figure presents a vivid comparison between them, which may be desirable for a potential buyer. Unlike a chart, each data point of the curves contains the sum of positive posts submitted over a period of time, like a day, a week or a month. The curve reveals both the historical trend and current status, which is advantageous over a chart. Besides addition of positive posts, the vertical axis may also represent the subtraction between the numbers of positive and negative posts, the quantity of all posts, the average grade over a period of time, etc. And more than two curves may be displayed in a figure to show comparison among more items.

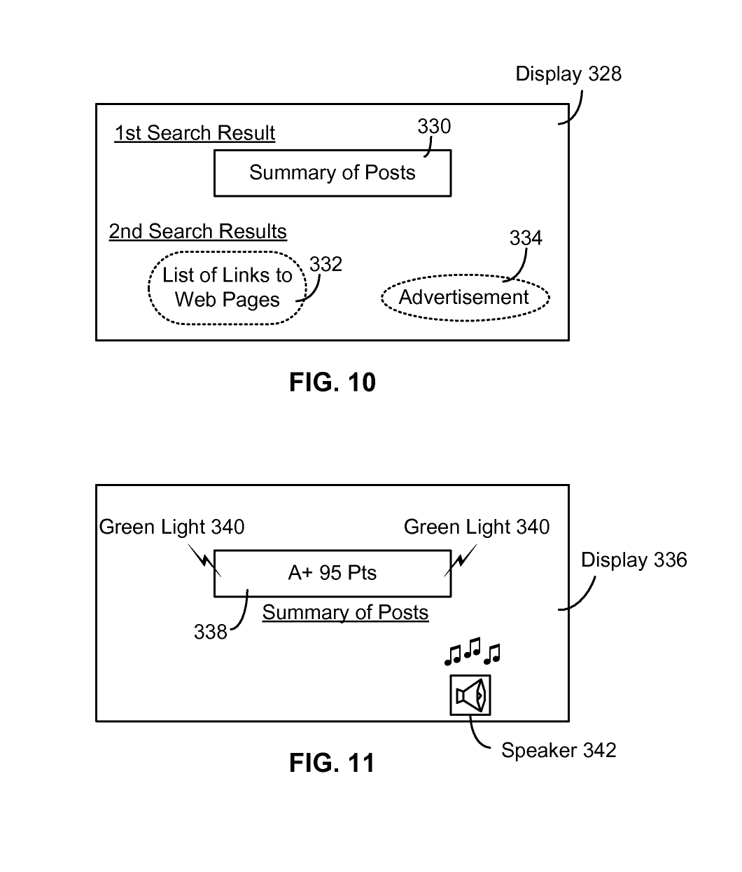

### FIGS. 10-15 Search Method and Search Result Presentation

FIG. 10 illustrates schematically an embodiment to conduct search and present search results. After a query is received, two searches are performed automatically, one looking for posts while the other a general search in a broader scope. For this and other embodiments, multiple searches may be performed automatically, either in sequence or in parallel, even though only one query is received. A display 328 may be of the screen of computer monitor, screen of smartphone, or the like. A window 330 may show a summary of the first search in response to a search query, which may be conducted by searching system 33 as illustrated in FIG. 4. On display 328, there is another window 332 which shows results of the second search, a general search, also performed by searching system 33, where the second search may be based on the same query. In addition, a window 334, the third one, may also be arranged on the display. Window 334 may display sponsor provided information or advertisements which may or may not be related to the query subject. For example, if a query is about seeking comments and opinions on brand V television, window 330 may show a concise summary of retrieved posts regarding opinions on brand V television, while window 332 may show search results with key words “brand V television” but in a search range beyond opinions, and window 334 may show a sign or a message provided by a sponsor who may want to advertise another brand of television of similar price. The results shown on window 332 may be similar to what is available from www.google.com or www.bing.com, i.e. list of links to web pages, which may contain various information on “brand V”, “television”, and “brand V television”. Thus a user may not only get a quick glance of comments on brand V television, but also links of related background info and current situation. Window 332 may also present a button which leads to a link list page. As a user is inquiring information on a product, the likelihood of purchasing the product by the user becomes higher. Thus advertisement may be more effective, and window 334 may be desirable for potential vendors. The searches for posts and other related information may be undertaken simultaneously or in sequence by searching system 33, as well know in the art.

FIG. 11 describes schematically another presentation method for search result. As depicted in the figure, a display 336 may present search results through multimedia means. A window 338 may show a summary of posts, such as “A+95 Pts”, which contains two parts A+ (meaning very good) and 95 points (out of 100). The summary is clear and concise, which may also be in other forms containing a few words, numbers, symbols, or combination. To make it quicker and more convenient to convey the summary result, a light emitting device may be employed. For example, it may be configured such that green light is emitted when a result is good, while red light flashes when a result is bad. As shown in the figure, a summary result and green light 340 are presented together, which may also be arranged in sequence. In addition, a summary may be presented by a video clip showing in window 338. Moreover, a speaker 342 may be used and a search summary may be presented by a piece of music or announcement. For example, certain music may be associated with good, so-so, or not good result respectively. With light or sound presentation method, receiving search result becomes more flexible and convenient for users.

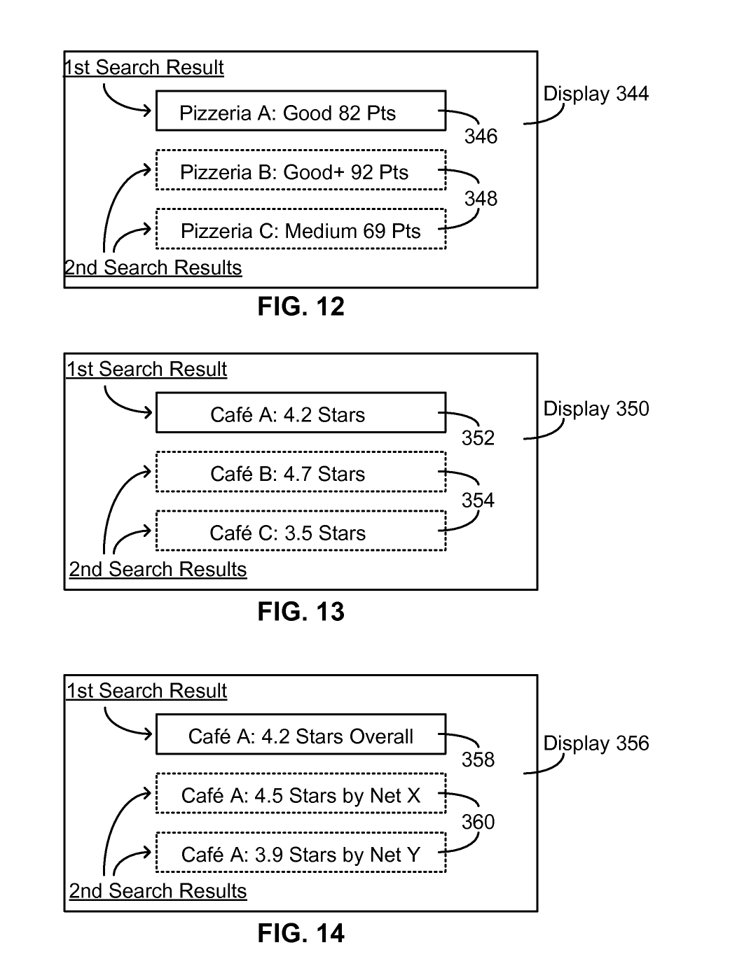

FIG. 12 shows exemplarily yet another embodiment to perform search and present search results. For example, when a user submits a query for opinions on Pizzeria A, a window 346 on a display 344 provides the first search and summary result: “Good 82 points” (out of 100 points), which may be produced by a remote search server. In a typical search case, showing of the result may be the end of it. But a result may make more sense when compared to its counterpart or competitor, with the latter two as a reference. Thus, in the exemplary figure, two more windows 348 are arranged to show the second search and summary results for Pizzeria B “Good+92 Pts” and Pizzeria C “Medium 69 Pts”. Pizzeria B and C are not part of the original query, but they may be in the same area and same business with Pizzeria A, and thus have the comparable value. The selection of Pizzeria B and C may be made by the server and/or users. The selection conditions may include geographic consideration in addition to category factors, since in many cases comparison between two businesses in the same area is desirable for potential customers. Thus the second search query may include location selection if the search is about local business. And in order to be comparable, the subjects of the first and second search may be in the same category or have similar characteristics. From the figure, it is clear that Pizzeria A is not the best, though not at the bottom. This scheme indicates that it helps when a server carries out multiple searches in response to one query and presents multiple concise search results for quick comparison of products or services. The method becomes even more useful for users with impending shopping decision inside a store, when the time is limited.

The scheme depicted in FIG. 12 may also be used to compare other factors besides results derived from auto analysis or auto summarization. Referring to FIG. 13, a display 350 shows the first search result in a window 352 based on a query about Café A. Assume every post has a star grading attached to it. The result, “4.2 stars”, is the average value over all posts. Since the absolute star grade has limited meaning, similar shops Café B and Café C may be selected automatically or by a user in the second search and their average star value is calculated and presented in windows 354, i.e. “4.7 stars” and “3.5 stars”. Café B and C are not related to the original search query, but they are in the same category and may be located in the same region. Thus the three places are comparable and the results of the second search are helpful reference for customers. Other items, like quantity of all posts, may also be used to reflect the status of the query subject. Therefore multiple searches in response to one query, where one search is based on the original query and other searches based on a different query, may make a searching event more meaningful and effective.

FIG. 14 shows yet another schematic diagram to illustrate search and presentation method according to present invention. On a display 356, search and summary result “4.2 Stars” for Café A in the first search appears in a window 358. The result is calculated by averaging all relevant star values of the posts. As the star value may come from multiple external sources, sometimes it may be desirable to list the results of external sources separately, since a user may have different views on the sources. Thus as an example, FIG. 14 displays in windows 360 the average result of Café A “4.5 stars” and “3.9 stars” using data from outside sources Net X and Net Y during the second search. The windows may also show results using different search and summarization strategies. Thus for one query, search results may be different, depending upon respective data source, search scope, or search method. Showing various search results may help users finding their unique need. The scheme illustrated in FIGS. 13 and 14 may be further enhanced when aforementioned auto summarization is incorporated.

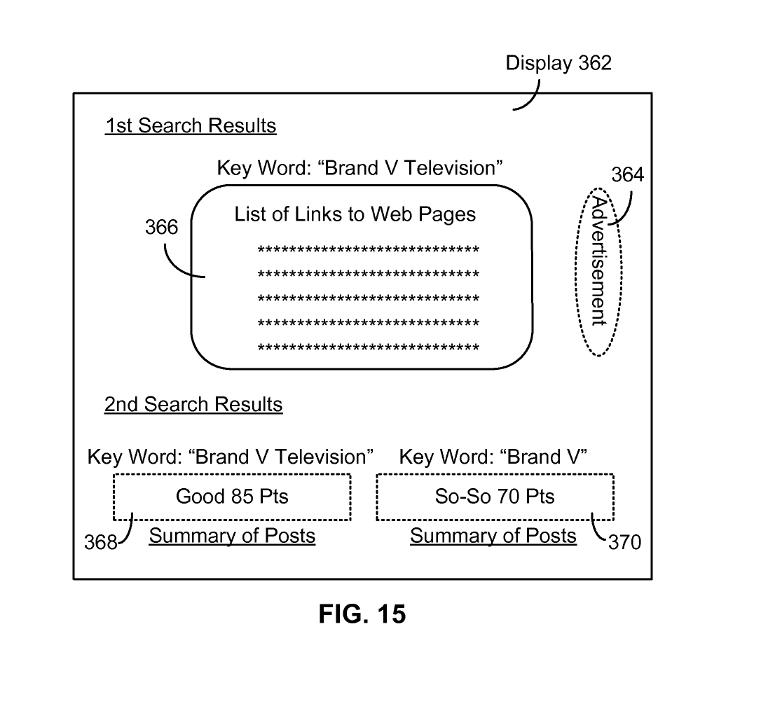

FIG. 15 depicts schematically yet another embodiment of search and presentation method. A search query contains key words “Brand V television”. It may start with a general search, which may be similar to what provided by search engines at www.google.com or www.bing.com. We call it the first search. Results of the first search based on the query appear in a window 366 on a display 362. The results, with a list of links to web pages related to the query, may look like a typical return from Google or Bing. As the query is about a product, the user may want to know other's comments and opinions. So the second search may be automatically launched on posts with the same query keywords “Brand V television”. A concise search summary “Good 85 Pts” may be made from the retrieved posts and shown in a window 368. To provide further information, the second search may also include searches based on modified key words “Brand V”, whose concise summary “So-So 70 Pts” may be displayed in a window 370. Thus, besides info from conventional search results, the user may simultaneously access thoughts and opinions from others, wherein the latter may play a more important role in product selection process. Similar to the configuration in FIG. 10, a window 364 may be arranged for advertising sponsor's products or messages. If a query is location sensitive, e.g. service related subjects, more searches on post may be arranged to get summaries on competitors in the area. The comparable search results may be displayed in windows 368 and/or 370 for quick and convenient viewing too.

Alternatively, window 364 may display another search summary which is sponsored by advertisers. The sponsored search may contain a query subject which the sponsor chooses. The sponsor selected subject may or may not be in the category of the original query subject, since a sponsor may want to have a show of a wide range of products.

### CONCLUSION, RAMIFICATIONS, AND SCOPE

Thus it can be seen that apparatus and methods are introduced to retrieve, process, and present search results on online posts.

The described embodiments have the following features and advantages:
(1). Convert numbers of posts into a concise summary for quick and easy viewing (As in FIG. 11);
(2). Complement a search on posts by a general search to provide more helpful information (As in FIG. 10);
(3). Complement a general search by a post search to provide others' opinions on a query object (As in FIG. 15);
(4). Perform multiple searches to provide comparable search results (As in FIGS. 12, 13, 14).

Although the description above contains many specificities, these should not be construed as limiting the scope of the invention but as merely providing illustrations of some of the presently preferred embodiments. Numerous modifications will be obvious to those skilled in the art.

### Ramifications:

The automatic summarization as aforementioned is not limited to textural posts. Other types of posts or user generated content such as a URL, audio, video, an image, and the like may be aggregated and processed to become easier to view as well. For example, voice recognition, image recognition, notes attached to non-text files, or origin or background of the non-text files, may be used or traced to identify the opinion, attitude, thought, or decision of a post.

In FIG. 8, items on the horizontal axis may be replaced by any group of comparable subjects, e.g. names of web sites or social network, like Facebook, Yelp, Amazon, Angie's List, Craigslist, etc.

In FIG. 12, the second search may include query subject in the same category or query subject in similar category. For example, Pizzeria C may be replaced by Café A, which may be desirable for users wanting a wider view, especially when there is limited pizzeria competition in the area.

Advertisement or sponsored message window in FIG. 10 may include another concise search result, when a sponsor wants to show similar or comparable product. Furthermore, a sponsor may also show in the ad window a search summary of other merchandise or service which may or may not be related to the original query.

Lastly, subjects of post which are suitable for auto summarization may include political, ideological, or cultural topics too. For example, auto summarization may be used to gauge popularity of a candidate among general public, or popularity of a movie, a song, or a singer. The popularity info may be useful for candidates, voters, promoters, or buyers.

Therefore the scope of the invention should be determined by the appended claims and their legal equivalents, rather than by the examples given.

1. A method performed by one or more servers comprising:
1) receiving a search query at said one or more servers from a user via a communication network;
2) retrieving a plurality of search results based on said search query by said one or more servers;
3) processing said search results by said one or more servers;
4) said processing step comprising at least one of the following processing sub-steps:
(a) automatically summarizing said search results for producing at least one substantially concise first summary, wherein said first summary includes at least one of a plurality of analytical items derived from automatic analysis, said analytical items comprising grade, numerical number, graphic expression, audio signal, or visual signal;
(b) automatically analyzing said search results for producing at least one substantially concise second summary, wherein said second summary contains one or less than fifty-one members, said members including word, letter, symbol, sign, numerical number, language character, or small image; and
5) transmitting the processed search results including said at least one first and/or second summary from said one or more servers to said user via said communications network.

2. The method according to claim 1 wherein said search query is transmitted to said one or more servers via a mobile device.

3. The method according to claim 1, further including providing advertisement or sponsored contents to said user.

4. The method according to claim 1 wherein more than one of said first and second summaries are arranged for displaying on one page.

5. The method according to claim 1 wherein the processed search results transmitted to said user include a plurality of links to web pages.

6. A system comprising one or more computing devices for providing information through searching and processing, comprising:
1) receiving means for receiving a search query at said one or more devices from a user via a communication network;
2) retrieving means for retrieving a plurality of search results based on said search query by said one or more devices;
3) processing means for processing said search results by said one or more devices;
4) said processing means comprising at least one of the following processing sub-means:
(a) analyzing means for automatically summarizing said search results for producing at least one substantially concise first summary, wherein said first summary includes at least one of a plurality of analytical items derived from automatic analysis, said analytical items comprising grade, numerical number, graphic expression, audio signal, or visual signal;
(b) summarizing means for automatically summarizing said search results for producing at least one substantially concise second summary, wherein said second summary contains one or less than fifty-one members, said members including word, letter, symbol, sign, numerical number, language character, or small image; and
5) transmitting means for transmitting the processed search results including said at least one first and/or second summary from said one or more computing devices to said user via said communications network.

7. The system according to claim 6 wherein said search query is transmitted to said one or more servers via a mobile device.

8. The system according to claim 6 wherein more than one of said first and second summaries are arranged for displaying on one page.

9. The system according to claim 6 wherein the processed search results transmitted to said user include a plurality of links to web pages.

10. The system according to claim 6, further including ad means for providing to said user advertisement or sponsored contents.

11. A method performed by one or more servers comprising:
1) receiving a first search query at said one or more servers from a user via a communication network;
2) obtaining a second search query;
3) retrieving a plurality of first search results based on said first query by said one or more servers;
4) retrieving a plurality of second search results based on said second query by said one or more servers;
5) processing said first and second search results by said one or more servers respectively;
6) said processing step comprising summarizing said first and second search results respectively for producing at least two substantially concise summaries; and
7) transmitting the processed first and second search results including said at least two summaries from said one or more servers to said user via said communications network.

12. The method according to claim 11 wherein said first search query is transmitted to said one or more servers via a mobile device.

13. The method according to claim 11 wherein said at least two summaries include at least one analytical item derived by automatic analysis.

14. The method according to claim 11, further including providing to said user advertisement or sponsored contents.

15. The method according to claim 11 wherein the processed first and second search results transmitted to said user include a plurality of links to web pages and/or sponsored contents.

16. A method performed by one or more servers comprising:
1) receiving a first search query at said one or more servers from a user via a communication network;
2) retrieving a plurality of first search results and a plurality of second search results respectively based on said first search query and/or a second search query by said one or more servers;
3) said method arranged such that said first and/or second search results include contents related to said first search query;
4) said method arranged such that said first and/or second search results include a plurality of links to web pages;
5) processing said first and/or second search results by said one or more servers;
6) said processing step comprising summarizing said first and/or second search results for producing at least one substantially concise summary; and
7) transmitting at least part of the links and said at least one substantially concise summary from said one or more servers to said user via said communications network.

17. The method according to claim 16 wherein said at least one substantially concise summary includes at least one analytical item derived by automatic analysis and/or sponsored contents.

18. The method according to claim 16 wherein said first search query is transmitted to said one or more servers via a mobile device.

19. The method according to claim 16, further including providing to said user advertisement or sponsored contents.

20. The method according to claim 16 wherein part of the links and said at least one concise summary are arranged for displaying on one page.
